(19) United States
(12) Patent Application Publication
(10) Pub. No.: US 2005/0271777 A1
(43) Pub. Date: Dec. 8, 2005

(54) Coffee impregnation system and method

(76) Inventor: Massimiliano Orsini, Eugene, OR (US)

Correspondence Address: KOLISCH HARTWELL, P.C., 520 S.W. YAMHILL STREET, SUITE 200, PORTLAND, OR, 97204, US

(21) Appl. No.: 10/861,107

(22) Filed: Jun. 3, 2004

(51) Int. Cl. A23L 1/31

(52) U.S. Cl. 426/281

(57) ABSTRACT

A method of roasting coffee is provided. Beans are roasted until they are dry and receptive to absorbing a concentrated aqueous additive such as a botanical solution before the second crack. The process results in a roasted coffee bean that is efficiently impregnated with a botanical substance that is available for reconstitution in brewed coffee.

### CROSS-REFERENCES

This application claims priority under 35 U.S.C. § 120 of PCT Application No. PCT/US02/39287 filed Dec. 6, 2002 titled “Coffee Impregnation System and Method,” which is hereby incorporated by reference in its entirety.

This application incorporates by reference in their entirety for all purposes: Ser. No. 60/337,202, filed Dec. 6, 2001 and Ser. No. 60/380,913, filed May 15, 2002.

### FIELD OF THE INVENTION

The invention relates to coffee roasting. In particular, the invention provides a new method for impregnating an additive such as a botanical substance into coffee beans.

### BACKGROUND OF THE INVENTION

Coffee roasting is an art and technique that has been practiced throughout the world for ages. In recent years, it has become increasingly popular to add substances to coffee, for example, to alter the natural flavor or affect of the roasted coffee bean. A common method of adding a substance to coffee involves mixing an alcohol-based flavor substance to the beans after the roasting process is terminated. The roasted beans are coated on the surface only. This produces an unpleasant oily coffee and diminishes the shelf life of the coffee. Currently, the most common way of adding botanical extracts or other substances to brewed coffee is simply to add liquid drops to coffee during or after the brewing process. This method is undependable and inefficient because the drink maker may add varying quantities of the additive and the substance may not always be homogeneously distributed in the coffee drink.

There is a need for a reliable method of impregnating enhancing substances into coffee beans. The method should enable substantial loading of beneficial substances into coffee. The method should not interfere with optimal roasting and brewing techniques.

### SUMMARY OF THE INVENTION

The invention provides systems, devices, and methods of roasting coffee in which an enhancer such as a botanical substance is introduced into coffee beans during the roasting process.

### BRIEF DESCRIPTION OF THE FIGURES

FIG. 1 is a flow-chart illustrating steps in a method of infusing an additive into coffee beans.

FIG. 2 is a graph illustrating temperature change in a roasting chamber as a function of time in a method of the invention.

FIG. 3 is a perspective view of a coffee roaster.

FIG. 4 is a schematic view of a coffee roaster equipped with an automated additive injection system.

### DESCRIPTION OF THE INVENTION

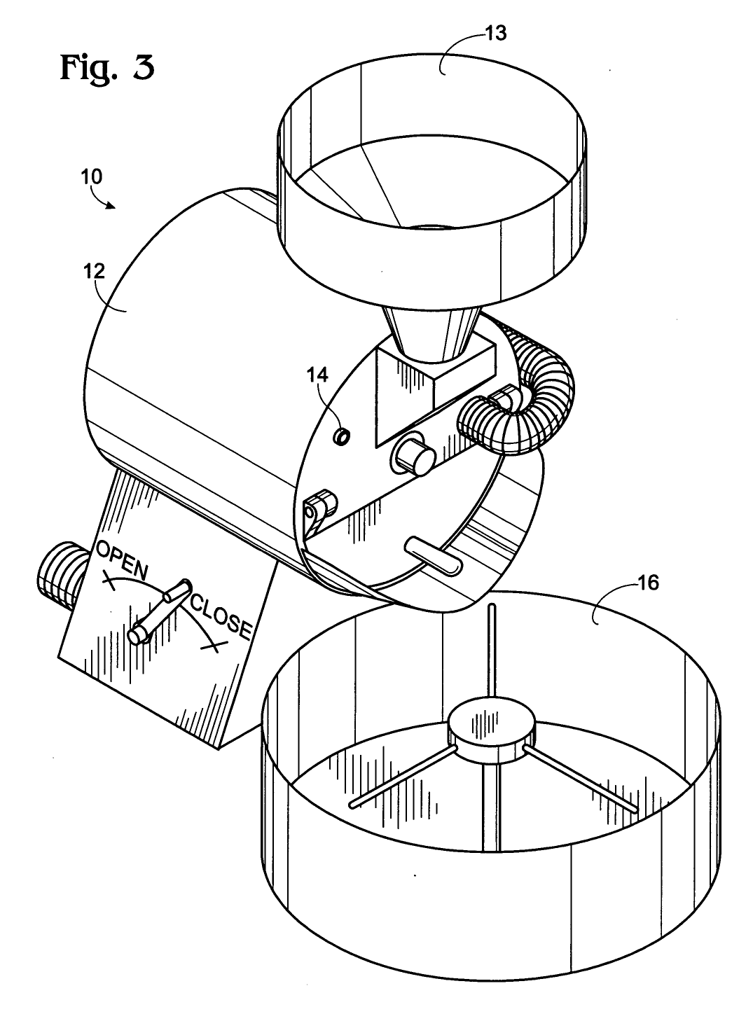

Coffee roasting has been universally practiced and refined around the world for hundreds of years. Coffee roasting is a time-temperature dependent process in which physical and chemical changes are induced beginning with green coffee. The process begins with the loading of green coffee beans into a roaster, such as the one shown in FIG. 3. The beans are typically dropped into the roasting chamber through a hopper, into a rotating cylinder equipped with internal paddles that keep the coffee tumbling and mixing. The rotating chamber is typically preheated to at least about 180° C. before adding green coffee beans to the chamber. The chamber is fueled by a heating source that may be electrical, natural gas, gas oil, or wood fueled.

In the rotating chamber, the heat is forced through a controlling air-flow valve which is capable of creating a vacuum environment. Convective hot air and radiant heat are used to heat the beans. In the first stage of the roasting process, the green beans become yellow. The temperature is increased to the boiling point of water, thus driving off the moisture in the beans. As the moisture trapped in the beans turns to steam, it breaks the cellular structure in the beans abruptly causing the beans to swell and to produce an audible crack, known as the “first crack”. The loss of moisture and other volatile compounds reduces the weight of the bean by about 14-25%. The size of the bean increases by about 40-60%. The first crack usually is reached after about 15 minutes of heating the beans to a temperature of about 170°-180°, preferably about 175° C.

The temperature continues to increase to about 180°-215°, preferably about 182°-194° C. The coffee beans lose most of the pre-existing water and the volume of the bean increases (from about 50-100% from the green form). As the temperature of the bean escalates, a complex series of chemical transformations occur. This process is called pyrolysis. Pyrolysis is the transformation by heat of the chemical components in the bean. There are literally hundreds of chemical compounds that make up a composition of green coffee. These compounds include oils, complex polysaccharides, sugars, starches, fats, waxes, and others. Some of these are broken down by the heat and driven off. Many compounds that are extracted during brewing are not present in green coffee, but instead develop as the coffee is roasted. Some starches are converted into sugar which caramelizes, accounting partially for the brown color. As roasting progresses, additional complex proteins and organic acids are broken down and transformed. The bean continues to grow in size, and becomes a darker brown. To produce a darker roast, the beans are left in the roaster longer. As the temperature continues to build, aromatic oils volatilize and boil toward the surface, eventually causing a “second crack” or popping. At the point of the second crack, the beans are close to combustion. If the beans are examined under a microscope at this point they will appear like a dry sponge ready to absorb water. The roasting process is typically stopped near, during, or after the second crack, depending on the roast master's objectives regarding color and flavor of coffee brewed from the roasted beans.

The invention provides a method of introducing or impregnating an enhancer such as a botanical substance, a vitamin, a flavor enhancer, or a therapeutic substance, into the coffee bean during the roasting process. An enhancer may be referred to as an additive substance which means that a material intended for incorporation in the coffee is carried in a solution or suspension formulated to result in a desired concentration of the material in the beans and/or coffee brewed from the beans. An objective of the invention is to introduce the additive substance to the bean at a time when it is most receptive, particularly, when it is very dry, large, and porous. For this purpose, an injection port is provided in the roasting chamber so that a substance, typically in a concentrated aqueous solution, can be introduced at the optimal time based on timing and temperature data.

After the first crack, the beans are continuously heated until shortly before the second crack. For example, the beans may be approximately 175° C. at the first crack, after which the beans are heated for about three more minutes to a temperature of about 184° C. At this point, a water-based concentrate containing the additive substance(s) of choice, is added to the roasting beans through an injection port in the roaster, for example, by spraying the concentrate directly at the beans as they are stirred and mixed by the rotating paddles. The amount of additive solution injected is between 1-15% by weight of the gross weight of the beans being roasted. The amount of additive may be from 5-10% or approximately 6% of the weight of the roasted beans.

Immediately prior to adding the additive solution, a partial vacuum environment may be created in the roasting chamber by adjusting the air flow valve(s). This may help draw and distribute the additive into the beans. For example, a vacuum environment may be created inside the roasting chamber by at least partially or totally closing the air intake channel or valve, and/or by at least partially or totally opening the air output channel or valve.

It is preferable to inject the solution before the second crack at which point the beans have lost the maximum amount of water and have reached such a high temperature that sugars and amino acids start crystallizing, and the oils of the beans move to the surface which may interfere with the correct absorption of water into the bean. The dryness of the beans makes them particularly receptive and absorbent to the water-based additive solution. Furthermore, before the second crack, the beans retain a certain amount of flexibility which help to attract the additive solution into the micro pores of the beans. However, the invention may be carried out by adding the concentrate after the second crack or anytime prior to cooling the beans.

Introduction of the water-based solution into the roasting chamber temporarily slows down or stops the temperature increase in the chamber. The injection may decrease the temperature of the roasting chamber briefly. Immediately, or shortly after completing the injection, the beans are transferred from the roasting chamber to the cooling tray. If the beans are left in the roaster too long after the injection step, then some active ingredients from the additive may volatilize from the beans.

The cooling process usually lasts about two minutes and produces a reduction back in size of the roasted coffee bean, thus allowing further sealing of the additive substance within the core of the coffee bean. From this point on, the coffee beans are impregnated with the extract or additive. The enhanced beans can be packaged, stored, ground, and brewed like regular coffee beans. When the beans are ground, the additive particles are exposed for reconstitution in brewed coffee and ultimate assimilation by the human body.

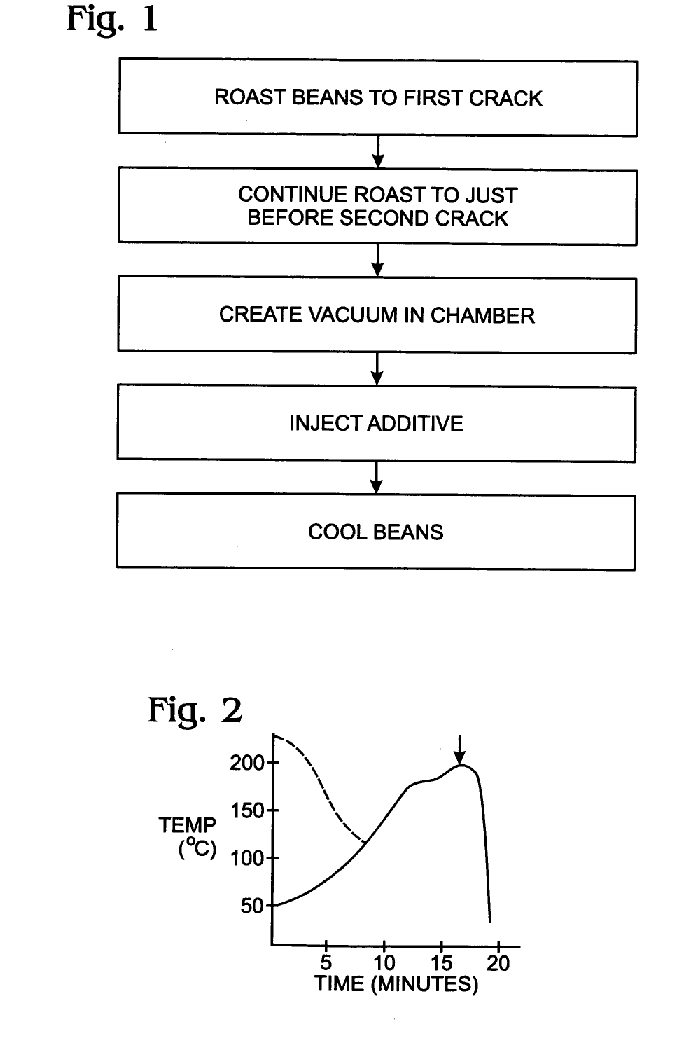

FIG. 1 shows a flow chart listing steps in a method of the invention. Green coffee beans are first roasted, for example beyond the first crack. A vacuum environment is created in the chamber. A concentrated aqueous additive solution is injected into the roasting chamber. Finally, the beans are cooled.

FIG. 2 shows a graph illustrating change in temperature in the roasting chamber as a function of time. The dashed line shows temperature change in the roasting chamber after green beans are placed in the chamber. Before introducing the beans, the chamber is pre-heated to over 200° C. The solid line represents the temperature of the beans. After about 15 minutes, the beans reach the first crack at a temperature of around 175° C. At this point, the temperature plateaus slightly and then increases again to approximately 185° C. The arrow in FIG. 2 indicates the point where the concentrated aqueous additive solution is injected into the roasting chamber. The temperature of the beans then plateaus or decreases slightly. The beans are then removed from the coffee roaster and allowed to cool.

FIG. 3 shows coffee roaster 10 including roasting chamber 12. Beans are loaded into chamber 12 through hopper 13. Roasting chamber 12 has an injection port 14. Cooling device or tray 16 receives beans from chamber 12 after finishing the roasting process.

Port 14 may be used typically to check the color of the coffee beans during the roasting process. Different methods and mechanisms of injection may be used to introduce the additive substance through port 14, depending on the roasting capacity of the equipment and the effective weight of the coffee being roasted. For example, a large syringe may be used to inject the aqueous botanical solution through port 14. A spray system may also be used. The dispensing device should be capable of introducing enough solution to the roaster so that the increase in temperature is temporarily stopped, thus avoiding and/or delaying the second crack.

The best time for injecting the solution is shortly before the second crack. It is also possible to inject the solution after the first crack. However, generally more solution will be absorbed in the beans if the injection is made closer to the second crack. It may also be possible to inject the solution after the second crack. However, this is less desirable because the beans tend to have more surface oil making it more difficult for the solution to penetrate the bean. Moreover, the plasticity of the beans is decreased so the beans will not reduce in size as much during the cooling process.

Each variety of bean, blend and/or additive may have a slightly different best time for injecting the solution. Generally, the determination about when to inject the solution may be a function of time, temperature, and/or visual appearance of the beans. It is possible to create a customized routine or timing profile for a particular variety of beans and/or blend. Other variables that may affect timing of the injection are equipment, ambient temperature, and humidity.

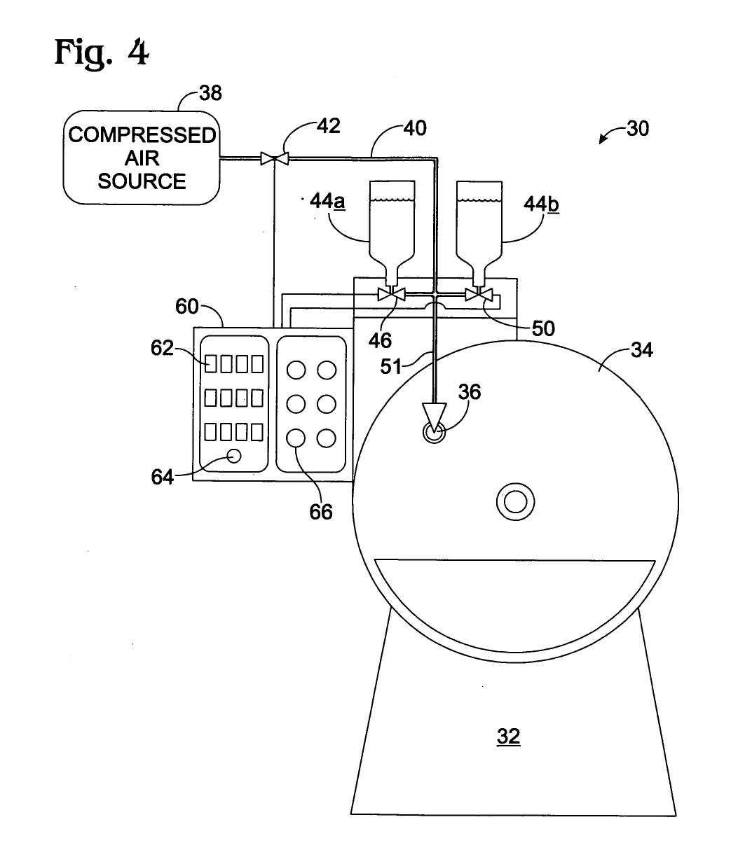

FIG. 4 shows schematically a system for controlling and partially or totally automating the additive injection procedure. Coffee roasting system 30 includes coffee roaster 32. Roasting chamber 34 is provided with injection port 36. Compressed air source 38 is connected to port 36 via air line 40. Solenoid valve 42 along air line 40 allows opening or closing of air line 40. Removable liquid vessels 44a and 44b are equipped with shut-off valves 46 and 50, respectively. Liquid vessels 44a and 44b may contain additive solutions or may also contain water for washing out section 51 of line 40. Control panel 60 allows an operator to control the roasting and injection process. For example, keys 62 may allow automated processing by presetting parameters such as roaster temperature, injection temperature, and liquid volume. Button 64 may allow the operator to go back and forth between automated and manual control. Buttons 66 may be used for manual control of the process.

### EXAMPLES

### Example 1

Bilberry-Infused Coffee Beans

I mixed 28 grams of Bilberry extract in 410 milliliters (mls) of water to make the Bilberry injection solution. The Bilberry extract has approximately 25% (w/w) active ingredients. I roasted 15 pounds (lbs) (weight after roasting) of Sumatran coffee beans. I injected the bilberry solution near the end of the roasting process. I transferred the beans from the roasting chamber to the cooling tray shortly after adding the Bilberry solution. I then assayed the coffee beans to determine how much Bilberry active ingredient was present in the coffee beans. I determined that there was 0.07% (w/w) Bilberry active ingredient in the coffee beans.

### Example 2

Ginseng-Infused Coffee Beans

I mixed 28 grams of Ginseng extract in 410 mls of water to make the Ginseng injection solution. I roasted 15 lbs (weight after roasting) of Sumatran coffee beans. I injected the Ginseng solution near the end of the roasting process. I transferred the beans from the roasting chamber to the cooling tray shortly after adding the Ginseng solution. I then assayed the coffee beans to determine how much Ginseng active ingredient was present in the coffee beans. I determined that there was 0.1% (w/w) Ginseng active ingredient in the coffee beans.

### Example 3

Ginger-Infused Coffee Beans

I repeated the procedure described in Examples 1 and 2 except with Ginger instead of Bilberry or Ginseng. The post roasting assay indicated similar results.

### Example 4

Echinacea-Infused Coffee Beans

I repeated the procedure described in Examples 1 and 2 except with Echinacea instead of Bilberry or Ginseng. The post roasting assay indicated similar results.

Although the invention has been disclosed in its preferred forms, the specific embodiments thereof as disclosed and illustrated herein are not to be considered in a limiting sense, because numerous variations are possible. Applicant regards the subject matter of his invention to include all novel and non-obvious combinations and subcombinations of the various elements, features, functions, and/or properties disclosed herein.

1. A method of roasting coffee comprising
providing a coffee roaster including a roasting chamber for containing and tumbling coffee beans, and a heating source connected to the roasting chamber adapted to heat the beans while the beans tumble and mix in the chamber, the chamber being provided with a port for accessing the beans during the roasting process,
loading coffee beans into the roasting chamber,
heating the beans while tumbling the beans in the roasting chamber until the beans are at least about 150° C.,
introducing an additive substance to the beans during the heating step, and
removing the beans from the roasting chamber to allow cooling of the beans after the introducing step.

2. The method of claim 1, wherein the introducing step includes the step of directing the additive substance toward the beans inside the chamber for at least about 15 seconds.

3. The method of claim 1, wherein the roasting chamber is equipped with one or more rotating paddle members for mixing the beans while roasting, further comprising the step of
directing the additive substance at the beans continuously over a period long enough for the one or more paddle members to cycle around the chamber at least about 5 times.

4. The method of claim 1, wherein the heating source uses one of the following for energy: electricity, gas, oil, and wood.

5. The method of claim 1, wherein the introducing step includes providing the additive substance in a concentrated aqueous solution, and spraying the solution on to the beans while the beans are tumbling and mixing.

6. The method of claim 5, wherein the amount of concentrated aqueous solution introduced to the beans is in the range of approximately 1-15% (w/w) of the weight of the beans being roasted.

7. The method of claim 1, wherein the additive substance includes an ingredient selected from the group consisting of botanicals, vitamins, flavor enhancers, therapeutic substances, and mixtures thereof.

8. The method of claim 1, wherein the additive substance includes an ingredient selected from the group consisting of echinacea, bilberry, ginseng, and ginger.

9. The method of claim 1, wherein the introducing step is carried out after the first crack.

10. The method of claim 1, wherein the introducing step is carried out after about two minutes from the first crack and before the second crack in the roasting process.

11. The method of claim 1, wherein the introducing step is carried out after the beans have expanded in volume by at least about 15%, but before the beans shrink in volume appreciably.

12. The method of claim 1, wherein the introducing step is carried out after the beans have decreased in weight by at least about 5%.

13. A method of roasting coffee comprising
providing a coffee roaster including a roasting chamber for containing and tumbling coffee beans, and a heating source connected to the roasting chamber adapted to heat the beans while the beans tumble and mix in the chamber, the chamber being provided with a port for accessing the beans during the roasting process,
loading green coffee beans into the roasting chamber,
heating the beans while tumbling the beans in the roasting chamber until the beans increase in volume by at least about 50%,
introducing an additive substance to the beans before the beans shrink in size significantly from their maximal volume attained during the heating step, and
removing the beans from the roasting chamber to allow cooling of the beans after the introducing step.

14. The method of claim 13, wherein the introducing step includes providing the additive substance in a concentrated aqueous solution, and spraying the solution on to the beans while the beans are tumbling and mixing.

15. The method of claim 14, wherein the amount of concentrated aqueous solution introduced to the beans is in the range of approximately 1-15% (w/w) of the weight of the beans being roasted.

16. The method of claim 13, wherein the additive substance includes an ingredient selected from the group consisting of Echinacea, bilberry, ginseng, and ginger.

17. The method of claim 13, wherein the introducing step is carried out after the first crack.

18. The method of claim 1, wherein the introducing step is carried out after the beans have expanded in volume by at least about 15%, but before the beans shrink in volume appreciably.

19. A method of roasting coffee comprising
providing a coffee roaster including a roasting chamber for containing and tumbling coffee beans, and a heating source connected to the roasting chamber adapted to heat the beans while the beans tumble and mix in the chamber, the chamber being provided with a port for accessing the beans during the roasting process,
loading green coffee beans into the roasting chamber,
heating the beans while tumbling the beans in the roasting chamber until the beans increase in volume by at least about 50%,
introducing an additive substance to the beans when the beans have attained their maximal volume during the heating step, and
removing the beans from the roasting chamber to allow cooling of the beans.

20. The method of claim 19, wherein the introducing step is carried out before removing the beans from the chamber.

21. The method of claim 19, wherein the roasting chamber is equipped with one or more rotating paddle members for mixing the beans while roasting, further comprising the step of
spraying the additive substance at the beans continuously over a period long enough for the one or more paddle members to cycle around the chamber at least about 5 times.

22. The method of claim 19, wherein the introducing step includes providing the additive substance in a concentrated aqueous solution, and spraying the solution on to the beans while the beans are tumbling and mixing.

23. The method of claim 22, wherein the amount of additive substance introduced to the beans is in the range of approximately 1-15% (w/w) of the weight of the beans being roasted.

24. The method of claim 19, wherein the additive substance includes an ingredient selected from the group consisting of Echinacea, bilberry, ginseng, and ginger.

25. The method of claim 19, wherein the introducing step is carried out after the first crack.

26. A method of roasting coffee comprising
providing a coffee roaster including a roasting chamber for containing and tumbling coffee beans, and a heating source connected to the roasting chamber adapted to heat the beans while the beans tumble and mix in the chamber, the chamber being provided with a port for accessing the beans during the roasting process,
loading green coffee beans into the roasting chamber,
heating the beans while tumbling the beans in the roasting chamber until the beans increase in volume by at least about 50%,
introducing an additive substance to the beans after the beans have attained their maximal volume while still in the roasting chamber or immediately after removing the beans from the roasting chamber.
